(19) United States
(12) Patent Application Publication
(10) Pub. No.: US 2025/0156744 A1
(43) Pub. Date: May 15, 2025

(54) HIGH-FIDELITY SYNTHETIC METRICS DATA

(71) Applicant: INTERNATIONAL BUSINESS MACHINES CORPORATION, Armonk, NY (US)

(72) Inventors: Ying Mo, BEIJING (CN); Wu Di, BEIJING (CN); Xing Tian, Beijing (CN); Ju Ling Liu, Beijing (CN); QING ZHI YU, Beijing (CN); Nan Chen, Beijing (CN); Gui Ying Jin, Changping district (CN); HUI GUANG LIU, Beijing (CN)

(21) Appl. No.: 18/388,596

(22) Filed: Nov. 10, 2023

(51) Int. Cl. G06N 20/00; G06F 17/14

(52) U.S. Cl. CPC G06N 20/00; G06F 17/14

(57) ABSTRACT

Embodiments monitor a target system to collect at least one data metric; pre-process the at least one data metric as a seed based on a predetermined policy; encode the pre-processed seed using a transform; post-process the encoded seed in a frequency domain; generate synthetic metrics data by applying an inverse transform to the post-processed seed; and train an artificial intelligence (AI) model using the generated synthetic metrics data.

### BACKGROUND

Aspects of the present invention relate generally to generating synthetic metrics data.

Artificial intelligence for information technology operations (AIOps) is a field that leverages artificial intelligence and machine learning techniques to enhance information technology (IT) management and operations. In AIOps, conventional tools may provide comprehensive monitoring and an observability platform across a plurality of distributed systems. In an example, the existing tools may generate a summary or a description of optimization rules.

### SUMMARY

In a first aspect of the invention, there is a computer-implemented method including: monitoring, by a processor set, a target system to collect at least one data metric; pre-processing, by the processor set, the at least one data metric as a seed based on a predetermined policy; encoding, by the processor set, the pre-processed seed using a transform; post-processing, by the processor set the encoded seed in a frequency domain; generating, by the processor set, synthetic metrics data by applying an inverse transform to the post-processed seed; and training, by the processor set, an artificial intelligence (AI) model using the generated synthetic metrics data.

In another aspect of the invention, there is a computer program product including one or more computer readable storage media having program instructions collectively stored on the one or more computer readable storage media. The program instructions are executable to: monitor a target system to collect at least one data metric; pre-process the at least one data metric as a seed based on a predetermined policy; encode the pre-processed seed using a transform; post-process the encoded seed in a frequency domain; generate synthetic metrics data by applying an inverse transform to the post-processed seed; and train an artificial intelligence (AI) model using the generated synthetic metrics data.

In another aspect of the invention, there is a system including a processor set, one or more computer readable storage media, and program instructions collectively stored on the one or more computer readable storage media. The program instructions are executable to: monitor a target system to collect at least one data metric; pre-process the at least one data metric as a seed based on a predetermined policy; encode the pre-processed seed using a transform; post-process the encoded seed in a frequency domain; generate synthetic metrics data by applying an inverse transform to the post-processed seed; capture a plurality of labels and values in the pre-processed seed; capture a plurality of logs and traces in the pre-processed seed; apply the plurality of labels, values, logs, and traces to the generated synthetic metrics data; and train an artificial intelligence (AI) model using the generated synthetic metrics data.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a computing environment according to an embodiment of the present invention.

FIG. 2 shows a block diagram of an exemplary environment in accordance with aspects of the present invention.

FIG. 3 shows an example of the pre-processing module in accordance with aspects of the present invention.

FIG. 4 shows an example of the pre-processing module in accordance with aspects of the present invention.

FIG. 5 shows an example of the pre-processing module in accordance with aspects of the present invention.

FIG. 6 shows an example of the pre-processing module in accordance with aspects of the present invention.

FIG. 7 shows an example of the visual impact of the recommendation in accordance with aspects of the present invention.

FIG. 8 shows an example of the visual impact of the recommendation in accordance with aspects of the present invention.

FIG. 9 shows an example of the visual impact of the recommendation in accordance with aspects of the present invention.

FIG. 10 shows an example of the visual impact of the recommendation in accordance with aspects of the present invention.

FIG. 11 shows an example of the visual impact of the recommendation in accordance with aspects of the present invention.

FIG. 12 shows an example of the visual impact of the recommendation in accordance with aspects of the present invention.

FIG. 13 shows an example of the visual impact of the recommendation in accordance with aspects of the present invention.

FIG. 14 shows an example of the visual impact of the recommendation in accordance with aspects of the present invention.

FIG. 15 shows an example of the visual impact of the recommendation in accordance with aspects of the present invention.

FIG. 16 shows an example of the visual impact of the recommendation in accordance with aspects of the present invention.

### DETAILED DESCRIPTION

Aspects of the present invention relate generally to generating synthetic metrics data and, more particularly, to generating high-fidelity synthetic metrics data for application performance management (APM) applications. Embodiments of the present invention provide a lightweight process for generating synthetic metrics data on demand. Embodiments of the present invention provide synthetic metrics data without a high-cost of setting up the environment. In particular, aspects of the present invention provide high-fidelity synthetics data for artificial intelligence (AI) model training and performance testing. Embodiments of the present invention provide the high-fidelity synthetics data with real-world anomalies in the synthetics data to facilitate accurate AI model training and reliable performance testing. Embodiments of the present invention also provide the high-fidelity synthetics data with correlation features including logs and traces to facilitate accurate AI model training and reliable performance testing.

Embodiments of the present invention also provide innovative and flexible data augmentation techniques which allow for filling gaps between multiple datasets captured in different time windows to ensure a continuous and connected dataset. Embodiments of the present invention provide the innovative and flexible data augmentation techniques to provide accurate and realistic synthetic metrics data. Embodiments of the present invention also provide predictive modeling techniques that enhance the generation of the synthetic metrics data. Embodiments of the present invention provide an alignment of a generated synthetic metrics data with an expected behavior of a target system by making reasonable predictions based on predetermined rules and known data. In particular, aspects of the present invention provide an accurate and realistic set of generated synthetics metrics data based on the predictive modeling techniques.

Embodiments of the present invention utilize at least one of a Fourier transform and a Wavelet transform to encode a pre-processed seed dataset. Embodiments of the present invention compress an original dataset in an encoding process, which allows for efficient storage and reconstruction of metrics data. Further, in embodiments of the present invention, an encoded representation of the metrics data includes a plurality of coefficients that are used to rebuild original data in an efficient and accurate manner.

Embodiments of the present invention correlate data metrics with other types of observability data, such as logs and traces. Embodiments of the present invention capture corresponding logs and traces with the data metrics, which enables a comprehensive understanding of a system behavior. Embodiments of the present invention enhance an effectiveness of troubleshooting by utilizing correlation data metrics with the observability data to improve anomaly detecting capabilities in comparison to conventional systems.

Embodiments of the present invention capture and recreate labels and values attached to the data metrics during generation of synthetic metrics data. Embodiments of the present invention correlate labels and values with the corresponding logs and traces by deriving the labels and values from a seed dataset using a plurality of rules. Embodiments of the present invention facilitate accurate analysis and interpretation of the generated synthetic metrics data.

Embodiments of the present invention monitor a target system for at least one period of time to capture specific system behavior and characteristics as seed datasets. Embodiments of the present invention provide flexibility in defining rules and policies for data augmentation, encoding, and prediction. Thus, embodiments of the present invention allow customization according to requirements of AI model training and performance testing. Further, embodiments of the present invention support scalability by enabling a generation of synthetic metrics data with predetermined sampling rates and time durations.

Embodiments of the present invention provide a computer-implemented method, a system, and a computer program product for generating high fidelity synthetic metrics data which includes traces, logs, and high quality metrics. In contrast, conventional systems merely provide additional time points within a time window which extends the time duration. Further, conventional systems also sample a segment of real data and duplicate the sampled segment to expand the time window. However, conventional systems are not able to provide high fidelity metrics. Embodiments of the present invention increase a quantity of metrics data within a predetermined time window and increase granularity while still ensuring high quality fidelity synthetic metrics data. Embodiments of the present invention provide high quality fidelity synthetic metrics data for facilitating AI model training and performance testing. Further, embodiments of the present invention provide high quality fidelity synthetic metrics data which preserves abnormal features within data metrics and correlation features, including logs and traces. Embodiments of the present invention also provide high fidelity synthetic metrics data which ensures consistency of frequency and amplitude by utilizing a Fourier transform to analyze original metrics data, identify patterns, and reconstruct the patterns.

Embodiments of the present invention include a highly computationally efficient system, method, and computer program product for generating high fidelity synthetics data. Accordingly, implementations of the present invention provide an improvement (i.e., technical solution) to a problem arising in the technical field of providing high quality fidelity data for AI model training and performance training. In particular, embodiments of the present invention generate a large amount of high quality fidelity data without incurring the high cost of setting up an environment. Also, embodiments of the present invention may not be performed in the human mind because aspects of the present invention provide encoding of metrics data, predict future trends of the metrics data based on existing frequency components in a frequency domain, and generate synthetic metrics data from a metrics payload template by applying an inverse transform on the encoded metrics data. Further, these implementations of the present invention include time series prediction techniques to connect multiple discrete datasets into a single continuous dataset. In addition, implementations of the present invention generate labels and values which correspond with logs and traces when generating the synthetic metrics data. Also, implementations of the present invention generate the synthetic metrics data on demand in real time or near real time to facilitate AI model training and performance testing.

Aspects of the present invention include a method, system, and computer program product for generating high quality synthetic metrics data. For example, a computer-implemented method includes: monitoring a target system to collect data metrics; enriching the collected data metrics by filling gaps between multiple datasets using time series prediction techniques; encoding the enriched data metrics by using a transform so that the data is compressed; predicting future trends based on existing frequency components in a frequency domain in the encoded data metrics; generating synthetic metrics data from a metrics payload template by applying an inverse transform on the encoded data metrics; and generating labels and values when generating the synthetic metrics data for correlating the labels and values to corresponding logs and traces.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as synthetic metrics code of block 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

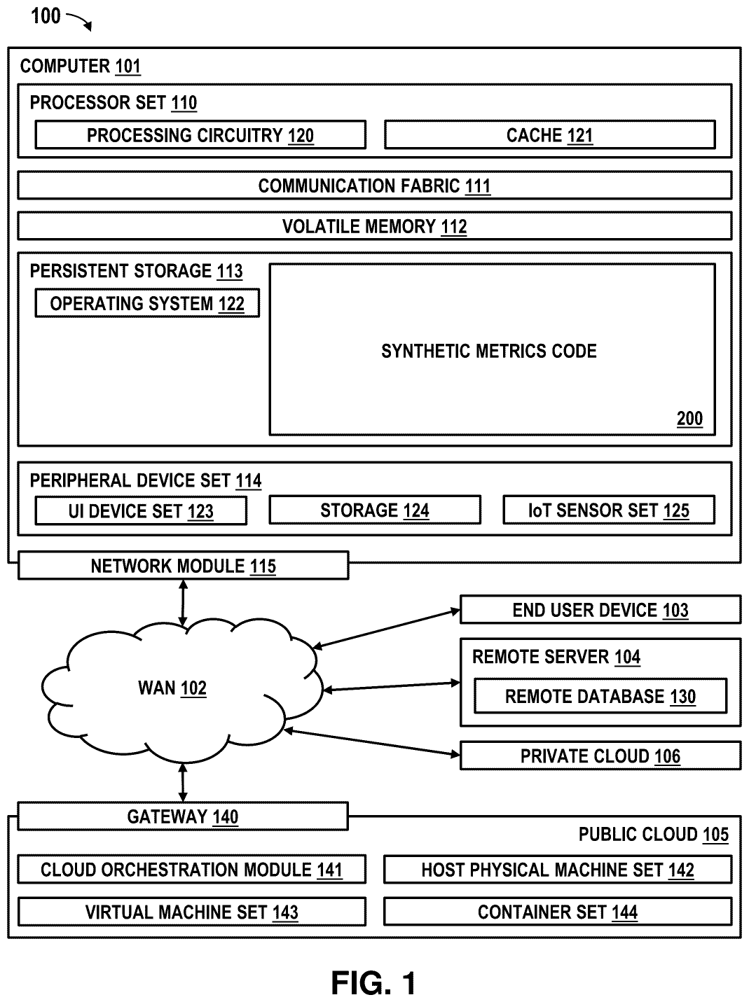

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

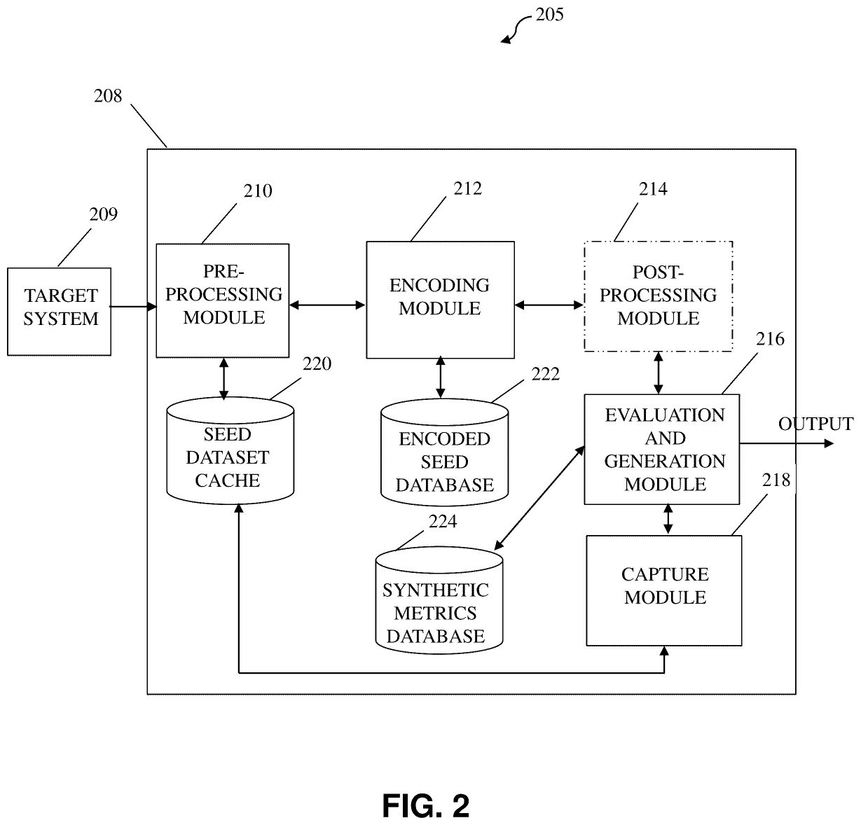

FIG. 2 shows a block diagram of an exemplary environment 205 in accordance with aspects of the present invention. In embodiments, the environment 205 includes a synthetic metrics server 208, which may comprise one or more instances of the computer 101 of FIG. 1. In other examples, the synthetic metrics server 208 comprises one or more virtual machines or one or more containers running on one or more instances of the computer 101 of FIG. 1.

In embodiments, the synthetic metrics server 208 of FIG. 2 comprises a pre-processing module 210, an encoding module 212, a post-processing module 214, an evaluation and generation module 216, and a capture module 218, each of which may comprise modules of the code of block 200 of FIG. 1. Such modules may include routines, programs, objects, components, logic, data structures, and so on that perform particular tasks or implement particular data types that the code of block 200 uses to carry out the functions and/or methodologies of embodiments of the present invention as described herein. These modules of the code of block 200 are executable by the processing circuitry 120 of FIG. 1 to perform the inventive methods as described herein. The synthetic metrics server 208 may include additional or fewer modules than those shown in FIG. 2. For example, the synthetic metrics server 208 may also include a seed dataset cache 220, an encoded seed database 222, and a synthetic metrics database 224. In embodiments, separate modules may be integrated into a single module. Additionally, or alternatively, a single module may be implemented as multiple modules. Moreover, the quantity of devices and/or networks in the environment is not limited to what is shown in FIG. 2. In practice, the environment may include additional devices and/or networks; fewer devices and/or networks; different devices and/or networks; or differently arranged devices and/or networks than illustrated in FIG. 2.

In accordance with aspects of the present invention, the pre-processing module 210 receives at least one data metric from a target system 209. In embodiments, the target system 209 comprises one of an application and a service which includes at least one data metric. In embodiments, the pre-processing module 210 monitors the target system 209 to collect the at least one data metric that a user is interested in for at least one period of time. In particular, the at least one data metric captures system behavior and characteristics of the target system 209 that a user wants to preserve when generating synthetic metrics data. For example, system behavior and characteristics of the target system may include but are not limited to CPU usage, processing times, an operating system version and characteristics, and software applications. Examples of the at least one data metric may also include but are not limited to model training data and testing data.

In embodiments, the pre-processing module 210 receives the at least one data metric from the target system 209 and utilizes the at least one data metric as a seed (e.g., a metrics seed dataset). Further, the pre-processing module 210 pre-processes the seed including the at least one data metric based on a predetermined policy. The pre-processing module 210 also defines a metric payload template from the at least one data metric. For example, the pre-processing module 210 pre-processes the seed including the at least one data metric by filling a plurality of gaps between a plurality of metric datasets in different time windows. In particular, the pre-processing module 210 fills the plurality of gaps between the plurality of metric datasets by using a time series prediction method to predict metric data between the plurality of metric datasets so that the plurality of metric datasets are connected together as a continuous metric dataset. In embodiments, the pre-processing module 210 may communicate with a seed dataset cache 220 to fill the plurality of gaps between the plurality of metric datasets in different time windows. The pre-processing module 210 sends the pre-processed seed including the at least one data metric to the encoding module 212. The pre-processing module 210 also sends the pre-processed seed including the at least one data metric to the seed dataset cache 220.

In embodiments of FIG. 2, the encoding module 212 encodes the pre-processed seed including the at least one data metric using a transform. In an example, the encoding module 212 encodes the pre-processed seed including the at least one data metric using a Fourier transform to transform the seed including the at least one data metric from a time domain to a frequency domain. In another example, the encoding module 212 encodes the pre-processed seed including the at least one data metric using a Wavelet transform to capture localized variations with fine-grained details from the pre-processed seed including the at least one data metric. The encoding module 212 sends the encoded pre-processed seed including the at least one data metric to the post-processing module 214. In addition, the encoding module 212 sends to the encoded pre-processed seed including the at least one data metric to an encoded seed database 222.

In embodiments of FIG. 2, the post-processing module 214 post-processes the encoded pre-processed seed including the at least one data metric. In embodiments, the post-processing module 214 post-processes the encoded pre-processed seed including the at least one data metric by predicting at least one new frequency component based on at least one existing frequency component to determine potential periodic patterns and predict future trends of the at least one data metric. The post-processing module 214 sends the post-processed encoded seed including the at least one data metric to the evaluation and generation module 216. In other embodiments of FIG. 2, the post-processing module 214 is an optional step (as represented by the dashed lines). In this scenario where the post-processing module 214 is not utilized in the synthetic metrics server 208, the encoding module 212 sends the encoded pre-processed seed including the at least one data metric directly to the evaluation and generation module 216.

In embodiments of FIG. 2, the evaluation and generation module 216 evaluates and saves a result of either the post-processed encoded seed including the at least one data metric or the encoded pre-processed seed including the at least one data metric in a situation where the post-processing module 214 is not utilized in the synthetic metrics server 208. In embodiments, the evaluation and generation module 216 evaluates the result based on a plurality of factors, such as a frequency contribution. As an example, the evaluation and generation module 216 evaluates the result by identifying dominant frequencies within a strong periodic or seasonal behavior to predict new frequency components.

In embodiments of FIG. 2, the evaluation and generation module 216 also generates synthetic metrics data by applying an inverse transform to either the post-processed encoded seed including the at least one data metric or the pre-processed encoded seed including the at least one data metric in the situation where the post-processing module 214 is not utilized in the synthetic metrics server 208. In an example, the evaluation and generation module 216 generates the synthetic metrics data by applying an inverse Fourier transform with a predetermined sampling rate and time duration. In another example, the evaluation and generation module 216 generates the synthetic metrics data by applying an inverse Wavelet transform with the predetermined sample rate and time duration. The evaluation and generation module 216 outputs the synthetic metrics data as an OUTPUT. In embodiments, the evaluation and generation module 216 trains an artificial intelligence (AI) model using the synthetic metrics data as the OUTPUT. The evaluation and generation module 216 also sends the synthetic metrics data to the capture module 218 and the synthetic metrics database 224.

In embodiments of FIG. 2, the capture module 218 receives the synthetic metrics data from the evaluation and generation module 216 and the pre-processed seed including the at least one data metric from the seed dataset cache 220. In embodiments, the capture module 218 captures labels and values attached in the pre-processed seed including the at least one data metric and also includes the labels and values in the synthetic metrics data. The capture module 218 also captures corresponding logs and traces in the pre-processed seed including the at least one data metric to apply the corresponding logs and traces to the synthetic metrics data to provide a correlation between logs, traces, labels, and values. The capture module 218 then sends back the synthetic metrics data with the applied corresponding logs and traces to provide the correlation between logs, traces, labels, and values to the evaluation and generation module 216. In this example, the evaluation and generation module 216 outputs the synthetic metrics data with the applied corresponding logs and traces to provide the correlation between logs, traces, and labels and values as the OUTPUT. In embodiments, the evaluation and generation module 216 trains an artificial intelligence (AI) model using the synthetic metrics data as the OUTPUT.

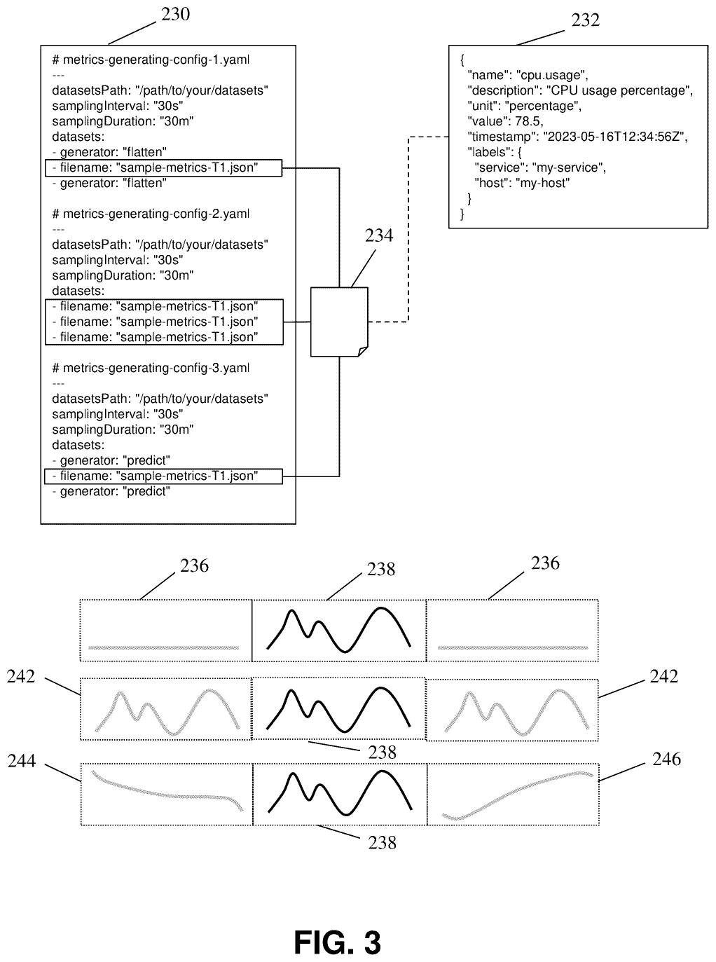

In accordance with aspects of the present invention, the pre-processing module 210 of FIG. 2 includes a metrics generating configuration file 230 which is used to organize at least one data metric that is captured from the target system 209. FIG. 3 shows an example of the pre-processing module in accordance with aspects of the present invention. In embodiments of FIG. 3, the metrics generating configuration file 230 defines how to connect the at least one data metric as a pre-processing step using a predetermined policy such that a plurality of discrete time series datasets can be connected together as a single continuous dataset. In embodiments, the metrics generating configuration file 230 includes a datasetsPath, a samplingInterval, a samplingDuration, datasets, generator, and a filename. In one example, datasetsPath is a path to the datasets which may include multiple dataset files and each file includes a list of time series data for one type of metric. In this example, samplingInterval is a distance between metric points at which measurements are taken or the time which elapses between measurements. In this example, datasets is a list of metrics datasets either collected from the target system 209 or generated by at least one policy. In this example, generator is a policy used to generate metrics data. For example, “flatten” is defined as generating metrics at a horizontal line with value 0, “predict” is defined as generating metrics by a predicting trend based on existing metrics data, etc. In this example, filename is a file that contains metric data collected from the target system. As shown in FIG. 3, the filename listed in each of the configurations of the metrics generating configuration file 230 can be combined to a single file 234 (e.g., “sample-metrics_T1.json”). An example of the contents of the single file 234 is shown as a sample metrics dataset file 232. The sample metrics dataset file 232 is an example of a metric payload. In embodiments, a json format represents a Javascript® object notation formation which is used for storing and transporting data. Javascript is a registered trademark of Oracle.

With continued reference to FIG. 3, the pre-processing module 210 uses a generator policy of “flatten” to supplement a data metrics 238 from the target system 209 with a flatten line 236 before and after the data metrics 238 to form a first single continuous dataset. Further, the pre-processing module 210 uses a generator policy of “repeat” to supplement the data metrics 238 from the target system 209 with a repeat 242 before and after the data metrics 238 to form a second single continuous dataset. In addition, the pre-processing module 210 uses a generator policy of “predict” to supplement the data metrics 238 from the target system 209 with a first predict pattern 244 before the data metrics 238 and a second predict pattern 246 after the data metrics to form a third single continuous dataset.

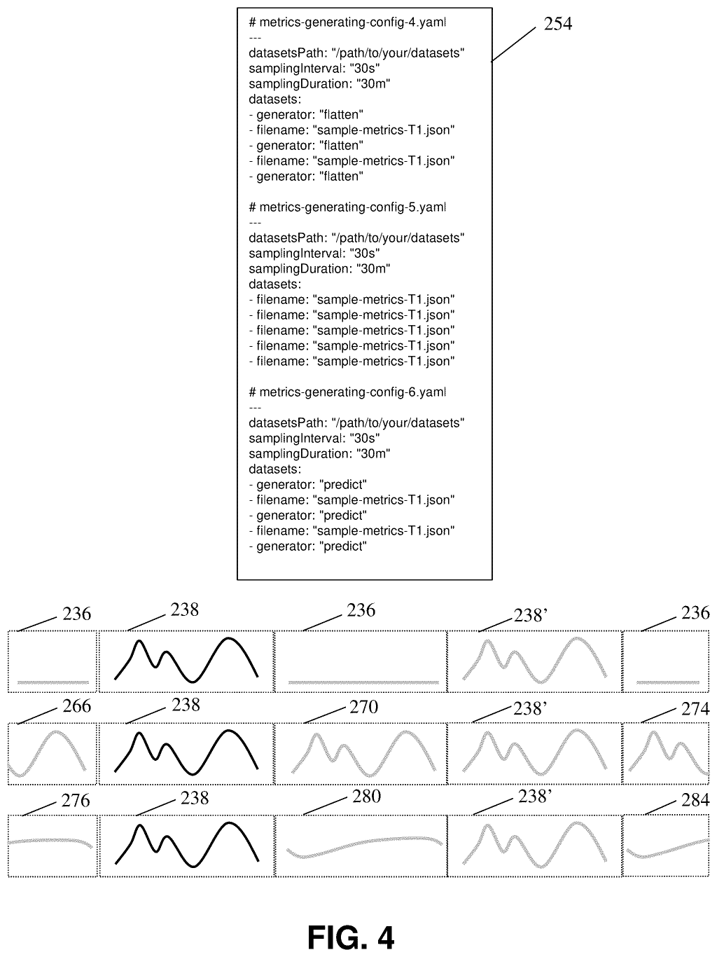

In accordance with aspects of the present invention, the pre-processing module 210 of FIG. 2 includes a metrics generating config file 254 which defines periodic or seasonality patterns explicitly in the synthetic metrics data for a single continuous dataset. FIG. 4 shows an example of the pre-processing module in accordance with aspects of the present invention. In embodiments of FIG. 4, the data metrics 238 may include a special system behavior or characteristic which recurs multiple times. In particular, the data metrics 238 may be a busy CPU usage at a peak time which is triggered by a job (e.g., cron job) which recurs every 30 minutes. In embodiments of FIG. 4, the pre-processing module 210 uses a generator policy of “flatten” to supplement the data metrics 238 from the target system 209 with a flatten line 236 before the data metrics 238, the flatten line 236 after the data metrics 238 and before a recurring data metrics 238′, and the flatten line 236 after the recurring data metrics 238′ to form a fourth single continuous dataset. Further, the pre-processing module 210 may use a generator policy of “repeat” to supplement the data metrics 238 from the target system 209 with a first repeat portion 266 before the data metrics 238, a second repeat portion 270 after the data metrics 238 and before the recurring data metrics 238′, and a third repeat portion 274 after the recurring data metrics 238′ to form a fifth single continuous dataset. In addition, the pre-processing module 210 may use a generator policy of “predict” to supplement the data metrics 238 from the target system 209 with a first predict pattern 276 before the data metrics 238, a second predict pattern 280 after the data metrics 238 and before the recurring data metrics 238′, and a third predict pattern 284 after the recurring data metrics 238′ to form a sixth single continuous dataset.

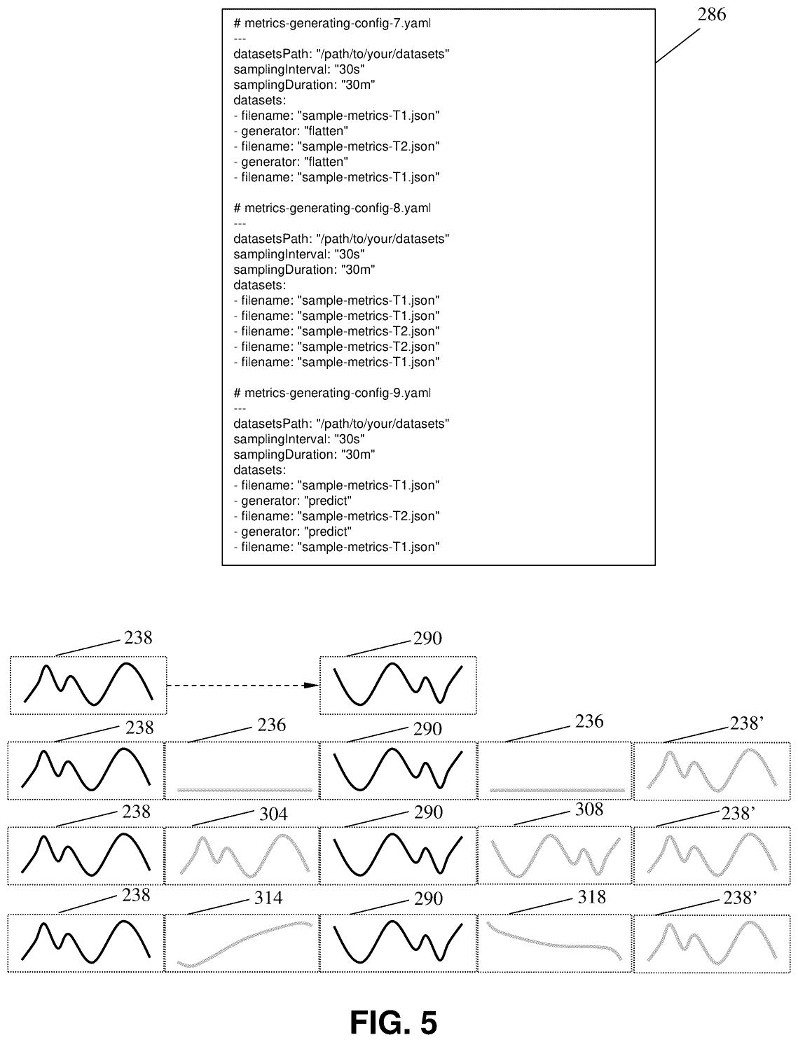

FIG. 5 shows an example of the pre-processing module in accordance with aspects of the present invention. In embodiments, the pre-processing module 210 includes a metrics generating config file 286 which defines multiple system behaviors or characteristics which are reflected by a metric that happens at different time windows. In particular, the metric generating config file 286 includes multiple separate datasets (e.g., data metrics 238 and data metrics 290 from the target system 209) which have fill-in gaps between the multiple separate datasets using at least one predetermined policy. For example, the data metrics 238 and data metrics 290 each reflect different system behaviors or characteristics within the metrics generating config file 286. For example, the data metrics 238 is represented by a first file (i.e., “sample-metrics_T1.json”) and the data metrics 290 is represented by a second file (i.e., sample-metrics_T2.json”) to reflect the different system behaviors or characteristics at different time windows specified in the metrics generating config file 286. In addition, the data metrics 238 recurs at a periodic or seasonality pattern, so that the recurring data metrics 238′ recurs multiple times within the metrics generating config file 286.

With continued reference to FIG. 5, the pre-processing module 210 uses a generator policy of “flatten” to supplement the data metrics 238 from the target system 209 with a flatten line 236 before the data metrics 290, the flatten line after the data metrics 290, and a recurring data metrics 238′ to form a seventh single continuous dataset. In embodiments of FIG. 5, the pre-processing module 210 uses a generator policy of “repeat” to supplement the data metrics 238 from the target 209 is with a first repeat portion 304 after the data metrics 238, a second repeat portion 308 after the data metrics 290, and the recurring data metrics 238′ to form an eighth single continuous dataset. In embodiments of FIG. 5, the pre-processing module 210 supplements a generator policy of “predict” to supplement the data metrics 238 from the target 209 with a first predict pattern 314 after the data metrics 238, a second predict pattern 318 after the data metrics 290, and the recurring data metrics 238′ to form a ninth single continuous dataset.

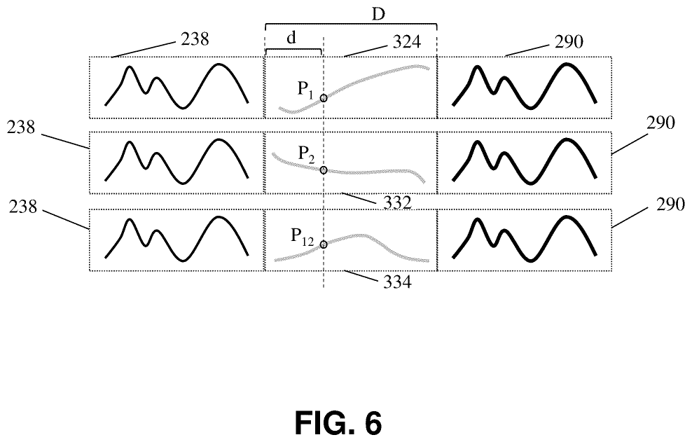

FIG. 6 shows an example of the pre-processing module in accordance with aspects of the present invention. In embodiments, the pre-processing module 210 utilizes time series prediction techniques to predict metric data between two datasets using the generator policy of “predict”. In an example, an enhanced autoregression model may be used to specify that an output variable linearly depends on previous values and a stochastic term. In embodiments of the present invention, the output variable depends on both previous values and future values, which are each weighted by a distance. In embodiments, FIG. 6 is an example of predicting metric data for a gap between data metrics 238 in one time window and data metrics 290 in another time window using the enhanced autoregression model.

With continued reference to FIG. 6, to smooth joining of the data metrics 238 in one time window and data metrics 290 in another time window, the pre-processing module 210 uses the enhanced autoregression model to generate data metrics 324 which depends on previous data points in data metrics 238. Then, the pre-processing module 210 re-orders the values of the data metrics 290 in reverse chronological order and then uses the enhanced autoregression model to generate data metrics 332 using the reversed chronologically ordered data metrics 290.

In embodiments of FIG. 6, the pro-processing module 210 generates the data metrics 334 based on data metrics 324 and data metrics 332, which are each weighted by a distance from a current point and a last point of data metrics 238. The distance represents a number of points in-between two points across data metrics 324 and data metrics 332. In embodiments, the pre-processing module 210 calculates a weight by Equation 1 below, in which w is a weight, D is a distance between the data metrics 238 and the data metrics 290, and d is a distance between a current point and a last point of the data metrics 238:

$$w = ( D - d ) / D . \qquad ( Equation 1 )$$

In embodiments of FIG. 6, the pre-processing module 210 calculates a final value of a data point P₁₂ in a data metrics 334 by Equation 2 below, in which P₁ is a value of a point in the data metrics 324 and P₂ is a value of a point in the data metrics 332:

$${P}_{12} = w * {P}_{1} + ( 1 - w ) * {P}_{2} . \qquad ( Equation 2 )$$

In embodiments of FIGS. 2-6, the pre-processing module 210 then sends the pre-processed seed including the at least one data metric as a single continuous dataset to the encoding module 212. In further embodiments of FIGS. 2-6, the pre-processing module 210 also sends the pre-processed seed including the at least one data metric as the single continuous dataset to the seed dataset cache 220 (as described and shown in FIG. 2).

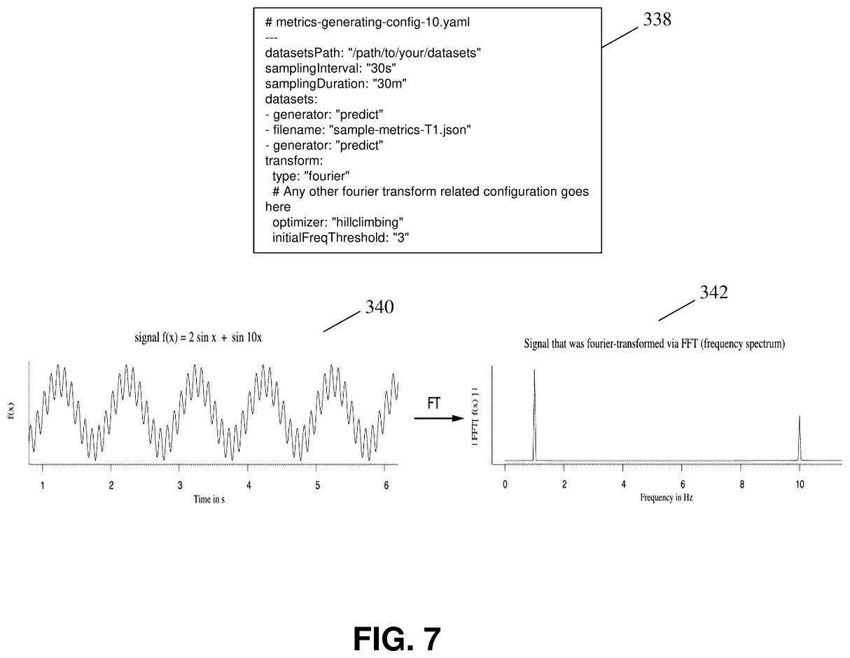

FIG. 7 shows an example of the visual impact of the recommendation in accordance with aspects of the present invention. In embodiments, the encoding module 212 encodes the pre-processed seed including the at least one data metric as the single continuous dataset by applying a transform. In an example, the encoding module 212 applies a Fourier transform to the pre-processed seed including the at least one data metric as the single continuous dataset. In embodiments, the Fourier transform is applied so that data points in a time domain are transformed to data points in a frequency domain and metrics with a timestamp are transformed to a frequency and an amplitude. In particular, the Fourier transform is a transform that converts a function into a form that describes multiple frequencies present in an original function (e.g., a series of sine and cosine functions) to extract different periodic patterns from a single time series variable. In particular, by using Equation 3 below, a Fourier Transform F is a function of a real variable ω, the function value F (ω) is in general a complex number, j is an imaginary number, dt is a derivative of time t, and |F(ω)| is an amplitude spectrum of the Fourier Transform F:

$$F ( ω ) = {\int }_{- ∞}^{∞} f ( t ) {e}^{- j ω t} dt . \qquad ( Equation 3 )$$

Equation 4 below is an equivalent form of the Fourier Transform F in Equation 3, in which F(ω) is represented as a function of sine and cosine:

$$F ( ω ) = {\int }_{- ∞}^{∞} f ( t ) cos ω tdt - j {\int }_{- ∞}^{∞} f ( t ) sin ω tdt . \qquad ( Equation 4 )$$

With continued reference to FIG. 7, the encoding module 212 uses the Fourier transform to handle the pre-processed seed including the at least one data metric as the single continuous dataset. In particular, the encoding module 212 uses the single continuous dataset (i.e., the continuous time series metrics seed dataset) as an input and outputs at least one frequency component with a value of amplitude for each frequency. In an example, a sample metric is transformed into two frequency components including a sine function with frequency 1 Hz and amplitude 2 and a sine function with frequency 10 Hz and amplitude 1. Therefore, when the encoding module 212 applies the Fourier transform, the function coefficients (e.g., [1 Hz, 2], [10 Hz, 1] are preserved and the original dataset can be dropped completely. In other words, the original dataset can be rebuilt by applying an inverse Fourier transform using only these function coefficients. The encoding module 212 stores these function coefficients as an encoded (i.e., compact) representation of the original dataset such that rebuilding the original dataset within a controlled approximate range can be accomplished in an efficient manner. In particular, the encoding module 212 stores the encoded original dataset in a very efficient manner in response to the number of the function coefficients being significantly smaller than the original dataset. Accordingly, the encoding module 212 provides very efficient storage and quick reconstruction of the synthetic metrics data. For example, in FIG. 7, the encoding module 212 includes a metrics generating config file 338 which defines a Fourier transform and an optimization algorithm (e.g., a hill climbing algorithm) with corresponding parameters. Further, FIG. 7 also shows an example of a signal 340 which includes the sine function with frequency 1 Hz and amplitude 2 and the sine function with frequency 10 Hz and amplitude 1 (i.e., signal f(x)=2 sin x+sin 10×). The signal 340 has time on the x-axis and the signal f(x) on the y-axis. The encoding module 212 applies a Fourier transform to the signal 340 via a Fast Fourier Transform (FFT) and outputs a Fourier-transformed signal 342. The Fourier-transformed signal 342 includes two function coefficients of [1 Hz, 2] and [10 Hz, 1] via FFT. The Fourier-transformed signal 342 is included in a graph with a frequency in hertz on the x-axis and |FFT f(x)| on the y-axis.

In FIG. 7, and in accordance with aspects of the present invention, after the encoding module 212 encodes the pre-processed seed including the at least one data metric as the single continuous dataset by applying a Fourier transform, all metrics data are transformed to frequencies and amplitudes. In embodiments, some transformed frequencies are noise and not useful for predicting metrics trends. In embodiments, the encoding module 212 filters out noise frequencies lower than a certain threshold and only keeps frequencies that have a real contribution to the metrics data. In this scenario, noise and metrics data are generally non-correlated. Thus, the encoding module 212 utilizes the hill climbing algorithm to find an optimal frequency threshold. The hill climbing algorithm sets up an initial frequency threshold for the data metrics as a current threshold and calculates a correlation value (i.e., a cost function) for an initial threshold. Then, the hill climbing algorithm increases or decreases the current threshold by a delta threshold and calculates a correlation value of a new frequency threshold. In response to the correlation value of the new frequency threshold being lower than the current threshold, the new frequency threshold is set as the current threshold. In contrast, in response to the correlation value of the new frequency being higher than the current threshold, the hill climbing algorithm goes to a final step. In the final step, in response to the current correlation being a lowest one between neighbor thresholds, the hill climbing algorithm is ended. Alternatively, in response to the current correlation not being the lowest one between neighbor thresholds, the hill climbing algorithm goes back to the step of calculating the correlation value of a new frequency threshold. Then, the step of calculating the correlation value of the new frequency threshold and the remaining steps after the step of calculating the correlation value of the new frequency threshold are repeated. In embodiments, calculating a correlation value involves filtering out all frequencies below a threshold, applying an inverse transform against remaining frequency components to regenerate the metrics data, and calculating a correlation between the regenerated metrics data and the original metrics data by calculating a difference between the regenerated metrics data and the original metrics data.

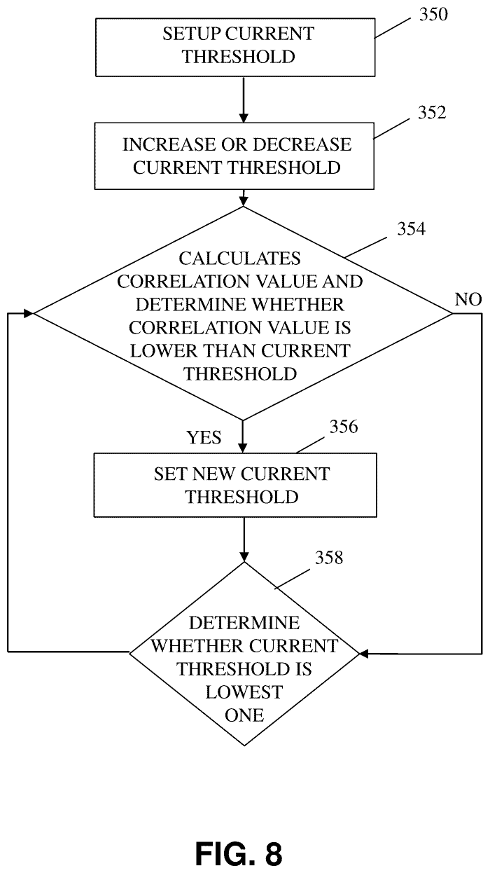

FIG. 8 shows a flowchart of an exemplary method in accordance with aspects of the present invention. Steps of the method may be carried out in the environment of FIG. 2 and are described with reference to elements depicted in FIGS. 2 and 7.

At step 350, the system setup a current threshold. In embodiments and as described with FIGS. 2 and 7, the encoding module 212 sets up an initial frequency threshold for the data metrics as the current threshold and calculates a correlation value (i.e., a cost function) for an initial threshold. At step 352, the system, increases or decreases, at the encoding module 212 utilizing the hill climbing algorithm, the current threshold by a delta threshold.

At step 354, the system calculates, at the encoding module 212 utilizing the hill climbing algorithm, a correlation value of a new frequency threshold. Also, in embodiments and as described with FIGS. 2 and 7, the encoding module 212 determines whether the correlation value of the new frequency threshold is lower than the current threshold. In embodiments and as described with FIGS. 2 and 7, the encoding module 212 moves to step 356 in response to the correlation value of the new frequency threshold being lower than the current threshold. In embodiments and as described with FIGS. 2 and 7, the encoding module 212 moves to step 358 in response to the correlation value of the new frequency threshold not being lower than the current threshold.

At step 356, the system sets, at the encoding module 212 utilizing the hill climbing algorithm, the new frequency threshold as the new current threshold. At step 358, the system determines, at the encoding module 212, whether the current correlation is a lowest one between neighboring thresholds. In embodiments and as described with FIGS. 2 and 7, the encoding module 212 ends the hill climbing algorithm in response to the current correlation being a lowest one between the neighbor thresholds. In embodiments and as described with FIGS. 2 and 7, the encoding module 212 goes back to step 354 for calculating a correlation value of a new frequency and repeats the remaining steps after the step of calculating the correlation value of the new frequency threshold in response to the current correlation not being the lowest one between the neighbor thresholds.

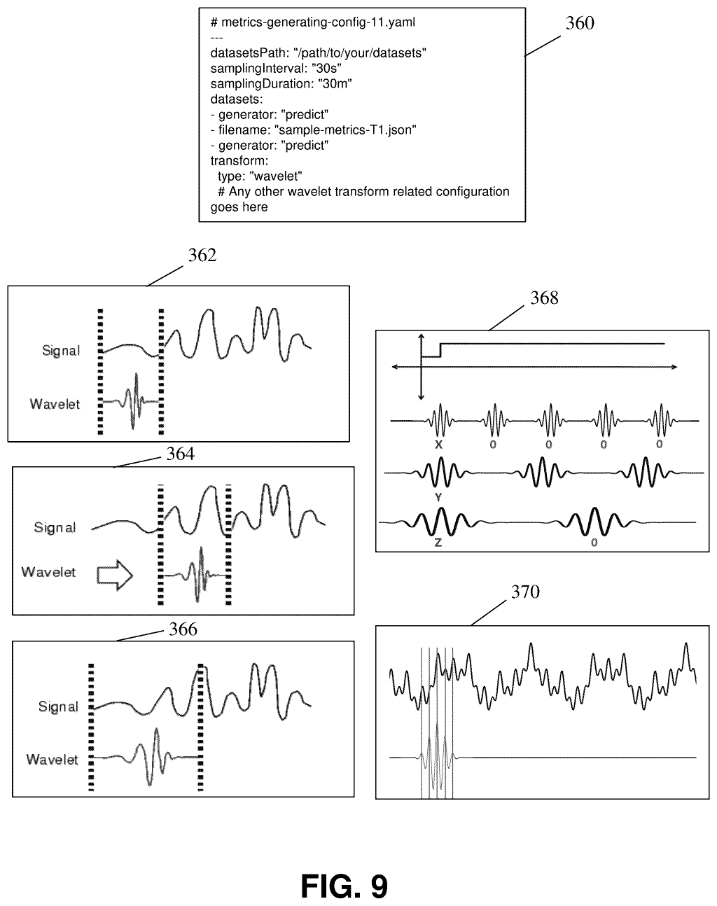

FIG. 9 shows an example of encoding a pre-processed seed in accordance with aspects of the present invention. In embodiments, the encoding module 212 encodes the pre-processed seed including the at least one data metric as the single continuous dataset by applying another transform instead of the Fourier Transform. In an example, since the Fourier Transform does not transform signals that have short intervals of a characteristic oscillation, such as signals that include a square wave or signals that include a zigzag wave well, another transform may be used instead of the Fourier Transform. In this example, the encoding module 212 encodes the pre-processed seed including the at least one data metric as the single continuous dataset by applying a Wavelet transform which decomposes a function into a set of wavelets and extracts local spectral and temporal information simultaneously.

With continued reference to FIG. 9, the encoding module 212 (of FIG. 2) may include a metrics generating config file 360 which defines the Wavelet transform to encode the pre-processed seed including the at least one data metric as the single continuous dataset. In particular, the encoding module 212 uses the Wavelet transform to transform a special signal (e.g., a square wave or a zigzag wave) to analyze metrics in different frequencies with different resolutions. In particular, the encoding module 212 uses the Wavelet transform with Equation 5 below to scale a continuous signal x(t) by a factor of a and shifted by a factor of b:

$$T ( a , b ) = \frac{1}{\sqrt{a}} {\int }_{- ∞}^{∞} x ( t ) ψ * \frac{( t - b )}{a} dt . \qquad ( Equation 5 )$$

In Equation 5 above, T(a, b) represents how closely correlated a wavelet is with a section in a metrics dataset of a signal. In particular, the higher the value of T (a, b), the more a similarity occurs between the wavelet and the metrics dataset of the signal. Further, the ψ* is a continuous function in both a time domain and a frequency domain and is referred to as a mother wavelet.

In embodiments of FIG. 9, the encoding module 212 encodes the pre-processed seed including the at least one dataset as the single continuous dataset by performing a plurality of steps using the Wavelet transform. In particular, the encoding module 212 uses the Wavelet transform to perform a first step of taking a wavelet and comparing the wavelet to a section at a start of the single continuous dataset and a second step of calculating the value of T(a, b). In FIG. 9, the first and second steps are shown in diagram 362. The encoding module 212 performs a third step of the plurality of steps using the Wavelet transform by shifting the wavelet to the right and repeating the previous step until the wavelet has covered the entire single continuous dataset. In FIG. 9, the third step is shown in diagram 364. The encoding module 212 performs a fourth step of the plurality of steps using the Wavelet transform by scaling the wavelet and repeating the first, second, and third steps. In FIG. 9, the fourth step is shown in diagram 366. The encoding module 212 performs a fifth step by repeating the plurality, the first, second, third, and fourth steps for all scales. In diagram 368, as a result of the first step and the second step, the wavelet is shown as being correlated with the beginning of metrics in the single continuous dataset and the value of T(a, b) is not equal to zero. In diagram 370, as a result of the fourth step, the wavelet is shown as being fully correlated with all of the metrics in the single continuous dataset. The encoding module 212 then sends the encoded pre-processed seed including the at least one data metric to the post-processing module 214.

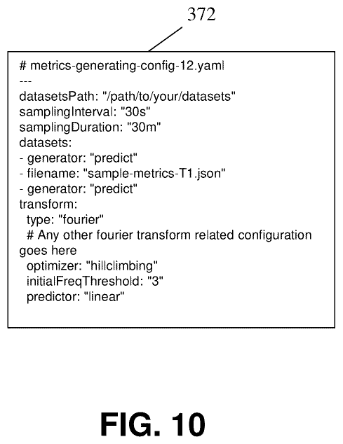

In FIG. 10, and in accordance with aspects of the present invention, the post-processing module 214 uses a regression model to estimate new values for the frequency components of one of the Fourier Transform or the Wavelet Transform to extend a time window and generate synthetic data. The regression model takes existing frequency components as input and predicts values for additional frequency components that correspond to frequencies beyond an original data window.

In embodiments of FIG. 10, the post-processing module 214 trains the regression model using existing frequency components. In particular, the post-processing module 214 has the frequency components as the input and amplitudes or phases of the corresponding frequencies in the extended time window as the target values. After the post-processing module 214 trains the regression model, the regression model is used to predict additional frequency components. In particular, the post-processing module 214 uses the regression model to estimate new frequencies that may occur in the extended time window based on patterns and trends observed in the at least one data metric. Further, by combining additional frequency components with existing frequency components, synthetic data can be reconstructed for the extended time window.

In embodiments of FIG. 10, the post-processing module 214 chooses the regression model based on the specific characteristics of the at least one data metric and a relationship between frequency components. For example, the post-processing module 214 chooses linear regression, polynomial regression, etc., depending on the complexity of the at least one data metric and a desired accuracy of generating synthetic data. An example of a metrics generating config file 372 which defines the regression model is shown in FIG. 10. However, performing the post-processing module 214 is an optional step (as represented by the dashed lines in FIG. 2). In embodiments, the post-processing module 214 performs post processing in situations where the at least one data metric exhibits strong periodic or seasonal behavior in which identifying dominant frequencies and predicting new frequency components helps to capture and reproduce the periodic or seasonal behavior patterns.

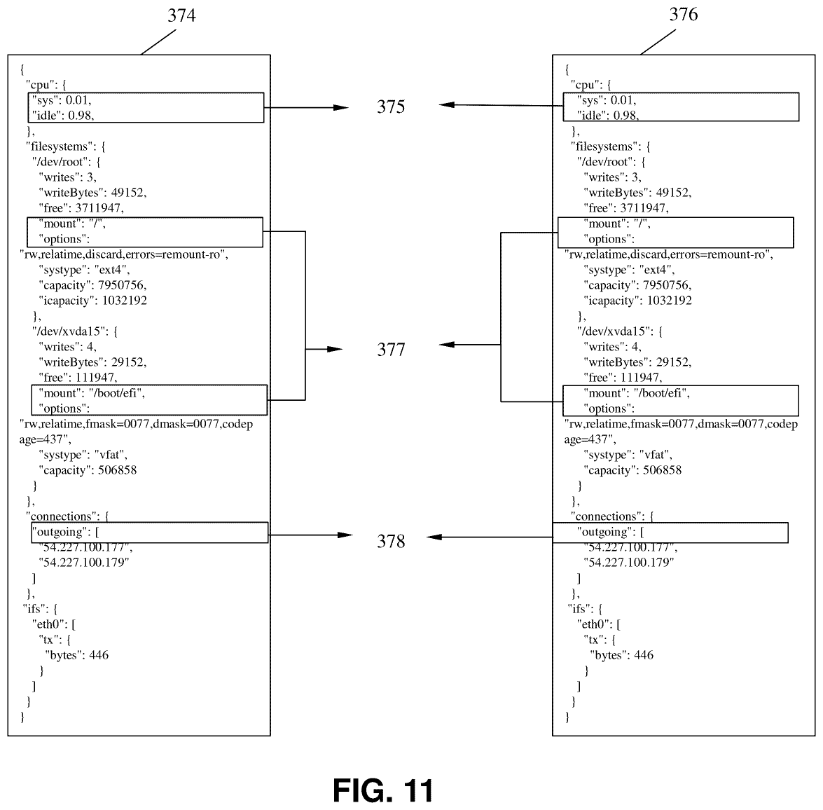

In FIG. 11, and in accordance with aspects of the present invention, the capture module 218 receives the synthetic metrics data from the evaluation and generation module 216 and the pre-processed seed including the at least one data metric from the seed dataset cache 220. In embodiments of FIG. 11, the at least one data metric from the pre-processed seed includes a raw metrics payload data 374 collected from the target system 209 at a predetermined timestamp. Further, in embodiments of FIG. 11, a synthetic metrics payload data 376 is also shown which is generated by the evaluation and generation module 216. In particular, the raw metrics payload data 374 aggregates many different types of metrics (e.g., CPU usage, disk I/O, etc.) within a same payload in a json format. Further, in embodiments, additional labels are also attached to the metrics which provide rich contextual information about the system.

In embodiments of FIG. 11, a common field in the raw metrics payload data 374 and the synthetics metrics payload data 376 is represented by metric data 375. The metric data is a numeric value which is tracked and generated using the synthetic metrics server 208. In further embodiments of FIG. 11, another common field in the raw metrics payload data 374 and the synthetic metrics payload data 376 is represented by constant labels 377. In embodiments, the constant labels 377 have values which are not changed throughout a time window. In embodiments of FIG. 11, another common field in the raw metrics payload data and the synthetic metrics payload data 376 is represented by variable labels 378. In embodiments of FIG. 11, the variable labels 378 have values which are changed throughout the time window. In embodiments, when generating the synthetic metrics payload data 376, both the constant labels 377 and the variable labels 378 will remain in the synthetic metrics payload data 376 along with the metric data 375.

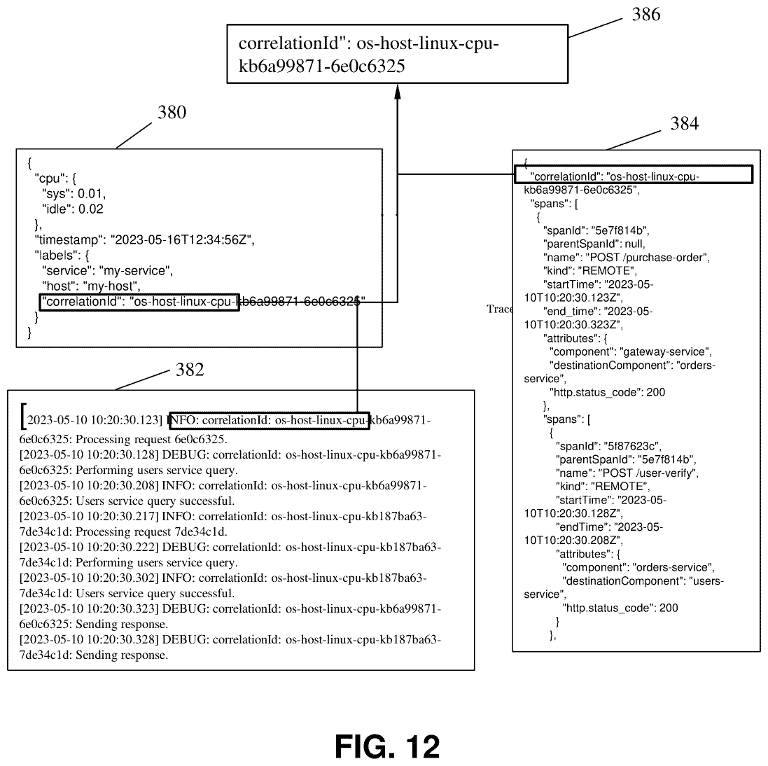

In FIG. 12, and in accordance with aspects of the present invention, the capture module 218 also captures corresponding logs and traces to apply the corresponding logs and traces to the synthetic metrics data to provide a correlation between logs, traces, and labels and values. In embodiments, the capture module 218 collects the corresponding logs and traces of the raw metrics payload data 374 and generating a correlation label 386. The capture module 218 generates the correlation label 386 and adds the correlation label 386 to the metrics data, the logs, and traces throughout the time window.

In embodiments of FIG. 12, the correlation label 386 is included in metrics data 380, the log data 382, and the trace data 384. In embodiments, a format of the correlation label 386 varies depending on a type of the target system 209. As an example, the correlation label 386 may include a format such as “<prefix>-<metric_id>-<random_number>”. This type of correlation label 386 is represented as one of the constant labels 377. Thus, the correlation label 386 is stored in the synthetic metrics payload data 376. As shown in FIG. 12, the correlation label 386 is represented as one of the constant labels 377 with a label of “correlationId”: os-host-linux-cpu-kb6a99871-6e0c6325″.

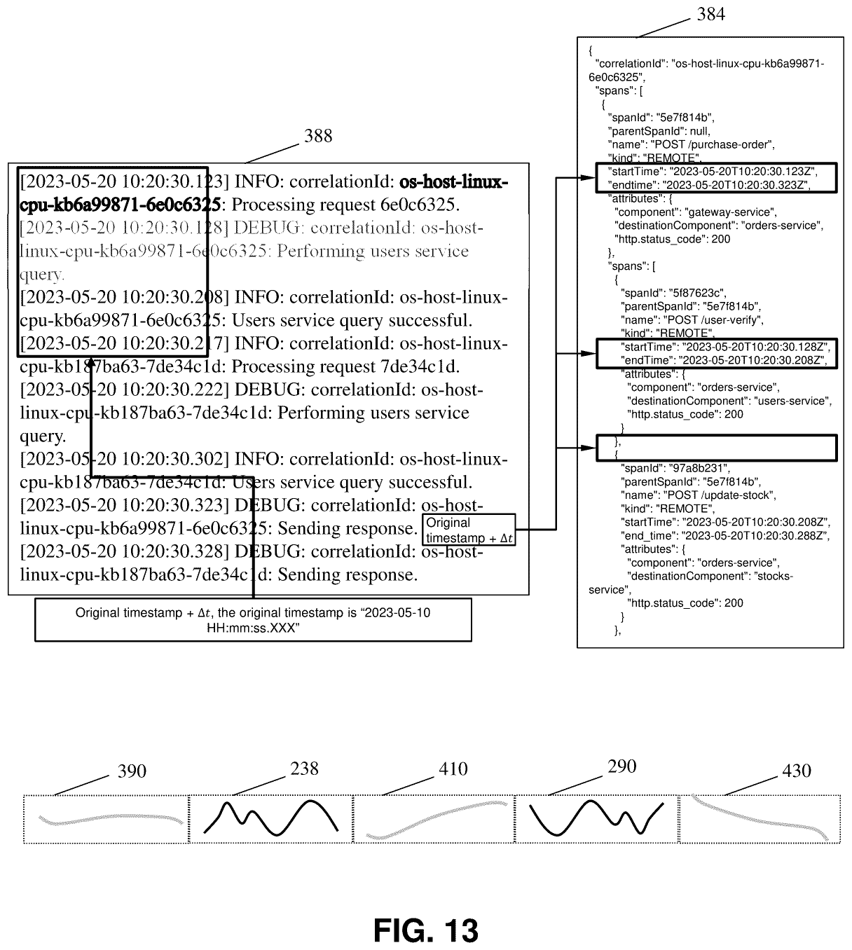

In FIG. 13, and in accordance with aspects of the present invention, the capture module 218 also generates synthetic logs and traces, along with the synthetic metrics, and preserves the correlation between the logs, traces, and metrics. In particular, the capture module 218 generates synthetic metrics using an inverse transform (e.g., one of an inverse Fourier transform and an inverse Wavelet transform) with the generated correlation label 386 (e.g., correlationId) stored in the synthetic metrics payload data 376. Then, the capture module 218 clones the corresponding logs and traces from the target system 209 with the same correlation label 386 (e.g., correlationId) as the logs and traces in the synthetic logs and traces and then updates timestamps of the logs and traces from the target system 209 to match with the timestamps of the logs and traces in the synthetic logs and traces.

In embodiments of FIG. 13, the data metrics 238 and the data metrics 290 are collected from the target system in separate time windows. The data metrics 238 and the data metrics 290 already have corresponding logs and traces correlated with the metrics since these corresponding logs and traces are already cloned from the target system 209. Since the timestamps of the data metrics 238 and the data metrics 290 includes timestamps from when they were collected, the timestamps need to be updated based on Equation 6 below:

$$Δ t = t 0 ’ - t 0. \qquad ( Equation 6 )$$

In Equation 6 above, t0 represents the timestamp of the first data point from a raw metrics dataset that are collected from the target system 209, 10′ represents the timestamp of the first data point in the synthetic metrics dataset, and Δt represents the time difference between the raw metrics dataset that are collected from the target system and the synthetic metrics dataset. The capture module 218 iterates timestamps over each item in the correlated logs and traces and adds Δt to the original timestamps to update the timestamps in the correlated logs and traces.

In embodiments of FIG. 13, for time windows other than the data metrics 238 and the data metrics 290 (e.g., filled gap portions 390, 410, and 430), the capture module 218 does not provide correlated logs and traces because the synthetic metrics server 208 preserves correlated logs and traces for data metrics collected from the target system 209 and not filled gap portions. In fact, the synthetic metrics server 208 provides synthetic logs and traces correlated with the data metrics 238 and the data metrics 290 to help train AI models inside observability products and solutions such as anomaly pattern detection. The synthetic metrics server 208 generates data outside of the time windows of the data metrics 238 and the data metrics 290 for enlarging a data size and extending a time window for better performance testing against the observability products and solutions. Further, the synthetic metrics server 208 generates data outside of the time windows of the data metrics 238 and the data metrics 290 by using simple rules for prediction models by predetermined policies used by the pre-processing module 210.

In embodiments of FIG. 13, the capture module 218 clones synthetic logs 388 from the trace data 384 collected from the target system 209 with adjusted timestamps. In this example, the delta time (Δt) is 10 days. However, embodiments are not limited to this example of a 10 day delta time.

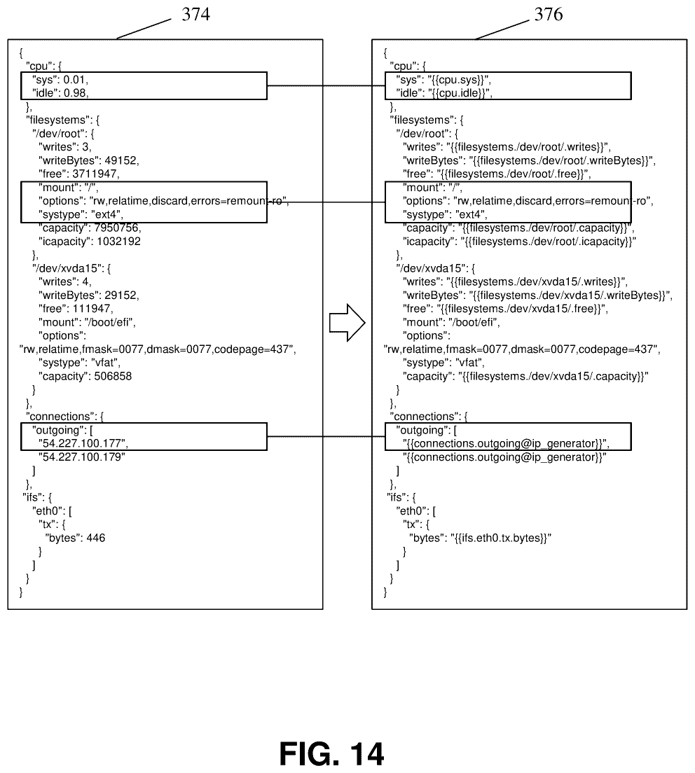

In FIG. 14, and in accordance with aspects of the present invention, the capture module 218 generates synthetic metrics data from a metrics payload template. The pre-processing module 210 defines a metrics payload template when preparing the metrics seed dataset and captures a structure of a metrics payload that is tied to the target system 209. In an example, multiple types of metrics data are aggregated within the same metrics payload template. Further, the metrics payload template includes some metrics labels, which can include both constant labels and variable labels. The constant labels and variable labels provide rich contextual information for the generated synthetic metrics data.

In embodiments of FIG. 14, the capture module 218 defines the metrics payload template by inheriting an overall structure from the raw metrics payload data 374 from the target system 209, replacing a numeric field value of a metric data with a placeholder defined using XPath, replacing a value of a variable metric label by a placeholder defined using XPath and appending with a policy (e.g., using @ annotation) to indicate how the value of the variable metric label is generated in the synthetic metrics payload data and preserving a value of a constant metric label in the metrics payload template. In embodiments, XPath uses path expressions to select nodes or node-sets in an extensible markup language (XML). In embodiments, the capture module 218 uses the metrics payload template by cloning the synthetic metrics payload from the metrics payload template, filling the numeric field value of the metric data, and determining locations to fill the numeric field value of the metric data by the XPath defined in the metrics payload template, and filling the value of the variable metric label from corresponding policies which are specified in the metrics payload temple and filling locations of the value of the variable metric label by the XPath defined in the metrics payload template. In embodiments, the numeric field value of the metric data is represented by a result of an inverse transform (e.g., one of an inverse Fourier transform and an inverse Wavelet transform) against encoded seed datasets. The capture module 218 will leave the constant metric labels as-is without any modifications.

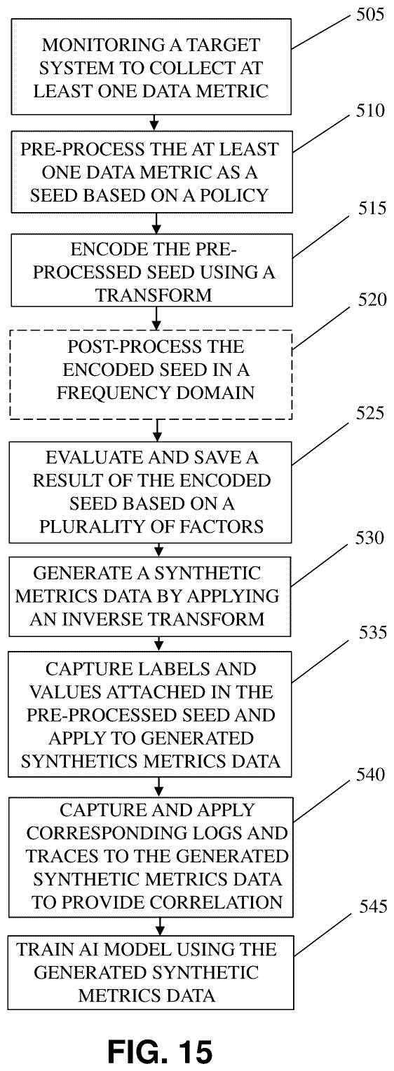

FIG. 15 shows a flowchart of an exemplary method in accordance with aspects of the present invention. Steps of the method may be carried out in the environment of FIG. 2 and are described with reference to elements depicted in FIG. 2.

At step 505, the system monitors, at the pre-processing module 210, the target system 209 to collect at least one data metric. In embodiments and as described with FIG. 2, the pre-processing module 210 collects the at least one data metric which includes system behavior and characteristics of the target system 209.

At step 510, the system pre-processes, at the pre-processing module 210, the at least one data metric as a seed based on a predetermined policy. In embodiments and as described with FIG. 2, the pre-processing module 210 pre-processes the at least one data metric as the seed by filling a plurality of gaps between a plurality of metric dataset captured in different time windows.

At step 515, the system encodes, at the encoding module 212, the pre-processed seed including the at least one data metric using a transform. In embodiments and as described with FIG. 2, the encoding module 212 encodes the pre-processed seed including the at least one data metric using a Fourier transform. In other embodiments and as described with FIG. 2, the encoding module 212 encodes the pre-processed seed including the at least one data metric using a Wavelet transform.

At step 520, the system post-processes, at the post-processing module 214, the encoded seed in a frequency domain. In embodiments and as described with FIG. 2, the post-processing module 214 post-processes the encoded seed by predicting at least one new frequency component based on at least one existing frequency component to determine potential periodic patterns and predicting future trends of the at least one data metric. In further embodiments, the step 520 may be an optional step.

At step 525, the system evaluates and saves, at the evaluation and generation module 216, a result of either the post-processed encoded seed including the at least one data metric or the pre-processed encoded seed including the at least one data metric in a situation where the post-processing module 214 is not utilized in the synthetic metrics server 208. In embodiments, and as described with FIG. 2, the evaluation and generation module 216 evaluates the result based on a plurality of factors, such as a frequency contribution.

At step 530, the system generates, at the evaluation and generation module 216, synthetic metrics data by applying an inverse transform to either the post-processed encoded seed including the at least one data metric or the pre-processed encoded seed including the at least one data metric in the situation where the post-processing module 214 is not utilized in the synthetic metrics server 208. In embodiments, and as described with FIG. 2, the evaluation and generation module 216 generates the synthetic metrics data by applying the inverse Fourier transform with a predetermined sampling rate and time duration.

At step 535, the system captures, at the capture module 218, labels and values attached in the pre-processed seed including the at least one data metric and applies the labels and values to the generated synthetic metrics data. In embodiments, and as described with FIG. 2, the capture module 218 applies the labels and values to the generated synthetic metrics data by including the labels and values in the generated synthetic metrics data.

At step 540, the system captures and applies, at the capture module 218, corresponding logs and traces to the generated synthetic metrics data to provide a correlation. In embodiments, and as described with FIG. 2, the capture module 218 captures the corresponding logs and traces attached in the pre-processed seed including the at least one data metric and applies the corresponding logs and traces to the generated synthetic metrics data by including the corresponding logs and traces in the generated synthetic metrics data.

At step 545, the system trains, at the evaluation and generation module 216, an artificial intelligence (AI) model using the generated synthetic metrics data.

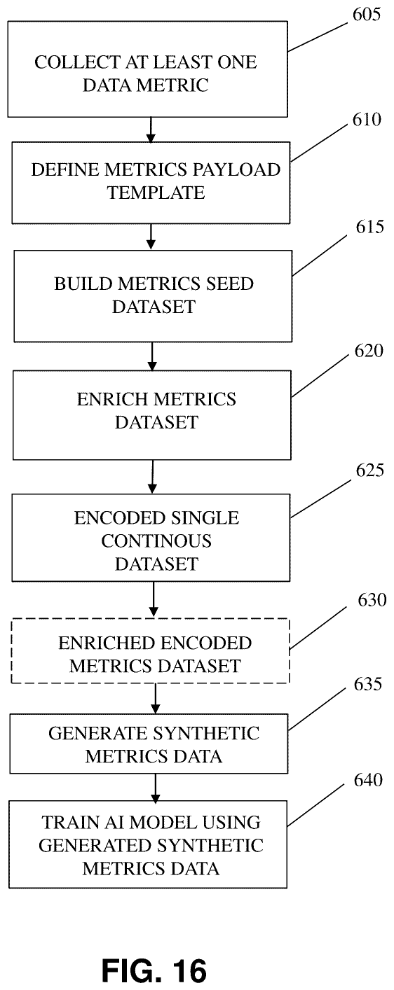

FIG. 16 shows a flowchart of an exemplary method in accordance with aspects of the present invention. Steps of the method may be carried out in the environment of FIG. 2 and are described with reference to elements depicted in FIGS. 2-14.

At step 605, the system collects, at the pre-processing module 210, the at least one data metric from a target system. At step 610, the system defines, at the pre-processing module 210, a metrics payload template from the at least one data metric. At step 615, the system builds, at the pre-processing module 210, a metrics seed dataset based on the metrics payload template from the at least one data metric. At step 620, the system enriches, at the pre-processing module 210, the metrics seed dataset by connecting multiple discrete datasets and introducing periodic patterns to a single continuous dataset.

At step 625, the system encodes, at the encoding module 212, the single continuous dataset by applying a transform. In embodiments and as described with FIG. 2, the encoding module 212 encodes the single continuous dataset by applying one of a Fourier transform and a Wavelet transform. At step 630, the system enriches, at the post-processing module 214, the encoded metrics dataset to find out potential periodic patterns and predict future trends of the metrics. In embodiments and as described with FIG. 2, step 630 is an optional step.

At step 635, the system generates, at the evaluation and generation module 216, the synthetic metrics data based on the encoded metrics dataset and the metrics payload template in response to not performing step 630. In other embodiments and as described with FIG. 2, the evaluation and generation module 216 generates the synthetic metrics data based on the enriched encoded metrics dataset in response to performing step 630.

At step 640, the system trains, at the evaluation and generation module 216, an artificial intelligence (AI) model using the generated synthetic metrics data.

In embodiments, a service provider could offer to perform the processes described herein. In this case, the service provider can create, maintain, deploy, support, etc., the computer infrastructure that performs the process steps of the present invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, the present invention provides a computer-implemented method, via a network. In this case, a computer infrastructure, such as computer 101 of FIG. 1, can be provided and one or more systems for performing the processes of the present invention can be obtained (e.g., created, purchased, used, modified, etc.) and deployed to the computer infrastructure. To this extent, the deployment of a system can comprise one or more of: (1) installing program code on a computing device, such as computer 101 of FIG. 1, from a computer readable medium; (2) adding one or more computing devices to the computer infrastructure; and (3) incorporating and/or modifying one or more existing systems of the computer infrastructure to enable the computer infrastructure to perform the processes of the present invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
monitoring, by a processor set, a target system to collect at least one data metric;
pre-processing, by the processor set, the at least one data metric as a seed based on a predetermined policy;
encoding, by the processor set, the pre-processed seed using a transform;
post-processing, by the processor set, the encoded seed in a frequency domain;
generating, by the processor set, synthetic metrics data by applying an inverse transform to the post-processed seed; and
training, by the processor set, an artificial intelligence (AI) model using the generated synthetic metrics data.

2. The computer-implemented method of claim 1, further comprising:
capturing a plurality of labels and values in the pre-processed seed; and
applying the captured labels and values to the generated synthetic metrics data by including the captured labels and values in the generated synthetic metrics data.

3. The computer-implemented method of claim 1, further comprising:
capturing a plurality of logs and traces in the pre-processed seed; and
applying the captured logs and traces to the generated synthetic metrics data by including the captured logs and traces in the generated synthetic metrics data.

4. The computer-implemented method of claim 1, wherein the at least one data metric comprises system behavior and characteristics of the target system.

5. The computer-implemented method of claim 1, wherein the pre-processing the at least one data metric as the seed comprises filling a plurality of gaps between a plurality of metric datasets captured in different time windows of the at least one data metric.

6. The computer-implemented method of claim 1, wherein the encoding the pre-processed seed using the transform comprises encoding the pre-processed seed using a Fourier transform.

7. The computer-implemented method of claim 1, wherein the encoding the pre-processed seed using the transform comprises encoding the pre-processed seed using a Wavelet transform.

8. The computer-implemented method of claim 1, wherein the post-processing the encoded seed in the frequency domain comprises predicting at least one frequency component based on at least one existing frequency component to determine potential periodic patterns and predict future trends of the at least one data metric.

9. The computer-implemented method of claim 1, further comprising evaluating a result of the pre-processed seed including the at least one data metric.

10. The computer-implemented method of claim 9, wherein the evaluating the result of the pre-processed seed including the at least one data metric comprises evaluating the result of the pre-processed seed including the at least one data metric based on a frequency contribution.

11. The computer-implemented method of claim 1, further comprising defining a metric payload template from the at least one data metric.

12. A computer program product comprising one or more computer readable storage media having program instructions collectively stored on the one or more computer readable storage media, the program instructions executable to:
monitor a target system to collect at least one data metric;
pre-process the at least one data metric as a seed based on a predetermined policy;
encode the pre-processed seed using a transform;
post-process the encoded seed in a frequency domain;
generate synthetic metrics data by applying an inverse transform to the post-processed seed; and
train an artificial intelligence (AI) model using the generated synthetic metrics data.

13. The computer program product of claim 12, further comprising:
capturing a plurality of labels and values in the pre-processed seed; and
applying the captured labels and values to the generated synthetic metrics data by including the captured labels and values in the generated synthetic metrics data.

14. The computer program product of claim 12, further comprising:
capturing a plurality of logs and traces in the pre-processed seed; and
applying the captured logs and traces to the generated synthetic metrics data by including the captured logs and traces in the generated synthetic metrics data.

15. The computer program product of claim 12, wherein the at least one data metric comprises system behavior and characteristics of the target system.

16. The computer program product of claim 12, wherein the pre-processing the at least one data metric as the seed comprises filling a plurality of gaps between a plurality of metric datasets captured in different time windows of the at least one data metric.

17. The computer program product of claim 12, wherein the encoding the pre-processed seed using the transform comprises encoding the pre-processed seed using a Fourier transform.

18. The computer program product of claim 12, wherein the post-processing the encoded seed in the frequency domain comprises predicting at least one frequency component based on at least one existing frequency component to determine potential periodic patterns and predict future trends of the at least one data metric.

19. The computer program product of claim 12, further comprising evaluating a result of the pre-processed seed including the at least one data metric.

20. A system comprising:
a processor set, one or more computer readable storage media, and program instructions collectively stored on the one or more computer readable storage media, the program instructions executable to:
monitor a target system to collect at least one data metric;
pre-process the at least one data metric as a seed based on a predetermined policy;
encode the pre-processed seed using a transform;
post-process the encoded seed in a frequency domain;
generate synthetic metrics data by applying an inverse transform to the post-processed seed;
capture a plurality of labels and values in the pre-processed seed;
capture a plurality of logs and traces in the pre-processed seed;
apply the plurality of labels, values, logs, and traces to the generated synthetic metrics data; and
train an artificial intelligence (AI) model using the generated synthetic metrics data.
